(19) United States
(12) Patent Application Publication
(10) Pub. No.: US 2026/0024850 A1
(43) Pub. Date: Jan. 22, 2026

(54) FOLDABLE POUCH BATTERY CELLS

(71) Applicant: FORD GLOBAL TECHNOLOGIES, LLC, Dearborn, MI (US)

(72) Inventors: Patrick Daniel Maguire, Ann Arbor, MI (US); Marc Dugas, Wixom, MI (US)

(21) Appl. No.: 18/779,334

(22) Filed: Jul. 22, 2024

(51) Int. Cl. H01M 50/136; H01M 50/105; H01M 50/178; H01M 50/531; H01M 50/548

(52) U.S. Cl. CPC H01M 50/136; H01M 50/105; H01M 50/178; H01M 50/531; H01M 50/548; H01M 2220/20

(57) ABSTRACT

Foldable pouch battery cells are provided for use within traction battery packs. An exemplary pouch battery cell may include flexible portions that can be folded to provide a more compact packaging design compared to conventional pouch style battery cells. The proposed designs move sensitive components of the pouch cell further away from a layered body of an electrode assembly of the pouch cell. The flexible portions of the pouch cell are capable of being bent by 90 degrees or more. The compact design facilities increased energy density compared to conventional pouch battery cell designs.

### TECHNICAL FIELD

This disclosure relates generally to pouch battery cells, and more particularly to pouch battery cells that may be folded or bent to provide more compact packaging configurations.

### BACKGROUND

A high voltage traction battery pack typically powers the electric machines and other electrical loads of an electrified vehicle. The traction battery pack includes a plurality of battery cells. Some traction battery packs utilize pouch battery cells.

### SUMMARY

A pouch battery cell according to an exemplary aspect of the present disclosure includes, among other things, an outer pouch, and an electrode assembly inside the outer pouch and including a layered body and a first plurality of electrode tabs that extend outward at a first side of the layered body. A first tab terminal is joined to the first plurality of electrode tabs and extends to a location that is outboard of a first trim edge of the outer pouch. A first foldable portion is provided immediately adjacent to the first side of the layered body.

In a further non-limiting embodiment of the foregoing pouch battery cell, the first foldable portion is established by an electrode extension area of the outer pouch and lengthened portions of the first plurality of electrode tabs.

In a further non-limiting embodiment of either of the foregoing pouch battery cells, each of the lengthened portions of the first plurality of electrode tabs extends between a first side of a transition area and a union arear of the outer pouch that is arranged outboard of the electrode extension area.

In a further non-limiting embodiment of any of the foregoing pouch battery cells, the first foldable portion is bent between about 90 degrees and about 180 degrees relative to a portion of the outer pouch that contains the layered body.

In a further non-limiting embodiment of any of the foregoing pouch battery cells, a distance between the first side of the layered body and the first trim edge is between about 23 mm and about 30 mm.

In a further non-limiting embodiment of any of the foregoing pouch battery cells, the electrode assembly includes a second plurality of electrode tabs that extend outward at a second side of the layered body. A second tab terminal is joined to the second plurality of electrode tabs and extends to a location that is outboard of a second trim edge of the outer pouch. A second foldable portion is provided immediately adjacent to the second side of the layered body.

In a further non-limiting embodiment of any of the foregoing pouch battery cells, the second foldable portion is established by an electrode extension area of the outer pouch and lengthened portions of the second plurality of electrode tabs.

In a further non-limiting embodiment of any of the foregoing pouch battery cells, the first plurality of electrode tabs are cathode electrode tabs, and the second plurality of electrode tabs are anode electrode tabs.

In a further non-limiting embodiment of any of the foregoing pouch battery cells, the second foldable portion is bent between about 90 degrees and about 180 degrees relative to a portion of the outer pouch that contains the layered body.

In a further non-limiting embodiment of any of the foregoing pouch battery cells, a distance between the second side of the layered body and the second trim edge is between about 23 mm and about 30 mm.

A pouch battery cell according to another exemplary aspect of the present disclosure includes, among other things, an outer pouch, and an electrode assembly inside the outer pouch and including a layered body and a first plurality of electrode tabs that extend outward at a first side of the layered body. A first tab terminal is joined to the first plurality of electrode tabs and extends to a location that is outboard of a first trim edge of the outer pouch. A first distance between the first side of the layered body and the first trim edge is between about 23 mm and about 30 mm.

In a further non-limiting embodiment of the foregoing pouch battery cell, the electrode assembly includes a second plurality of electrode tabs that extend outward at a second side of the layered body. A second tab terminal is joined to the second plurality of electrode tabs and extends to a location that is outboard of a second trim edge of the outer pouch.

In a further non-limiting embodiment of either of the foregoing pouch battery cells, the first distance extends between the second side of the layered body and the second trim edge.

In a further non-limiting embodiment of any of the foregoing pouch battery cells, a first foldable portion is provided immediately adjacent to the first side of the layered body.

In a further non-limiting embodiment of any of the foregoing pouch battery cells, the first foldable portion is established by an electrode extension area of the outer pouch and lengthened portions of the first plurality of electrode tabs.

In a further non-limiting embodiment of any of the foregoing pouch battery cells, each of the lengthened portions of the first plurality of electrode tabs extends between the first side of the layered body and a transition area of the outer pouch that is arranged outboard of the electrode extension area.

In a further non-limiting embodiment of any of the foregoing pouch battery cells, the first foldable portion is bent between about 90 degrees and about 180 degrees relative to a portion of the outer pouch that contains the layered body.

In a further non-limiting embodiment of any of the foregoing pouch battery cells, a second foldable portion is provided immediately adjacent to a second side of the layered body.

In a further non-limiting embodiment of any of the foregoing pouch battery cells, the second foldable portion is bent between about 90 degrees and about 180 degrees relative to a portion of the outer pouch that contains the layered body.

In a further non-limiting embodiment of any of the foregoing pouch battery cells, the second foldable portion is established by an electrode extension area of the outer pouch and lengthened portions of a second plurality of electrode tabs of the electrode assembly.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a traction battery pack of an electrified vehicle.

FIG. 3 illustrates a conventional pouch battery cell.

FIG. 4 illustrates a foldable pouch battery cell.

FIG. 5 illustrates the foldable pouch battery cell of FIG. 4 in a folded or compact configuration.

### DETAILED DESCRIPTION

This disclosure details foldable pouch battery cells for use within traction battery packs. An exemplary pouch battery cell may include flexible portions that can be folded to provide a more compact traction battery packaging design compared to conventional pouch style battery cells within a traction battery. The proposed designs move sensitive components of the pouch cell further away from a layered body of an electrode assembly of the pouch cell. The flexible portions of the pouch cell are capable of being bent by 90 degrees or more. The compact design facilities increased energy density of a traction battery compared to that provided by conventional pouch battery cell designs. These and other features are discussed in greater detail in the following paragraphs of this detailed description.

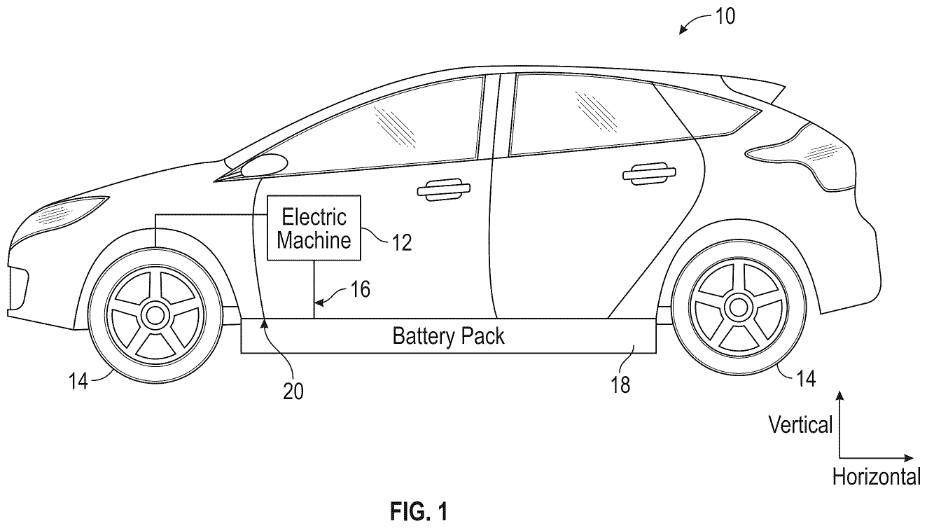

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

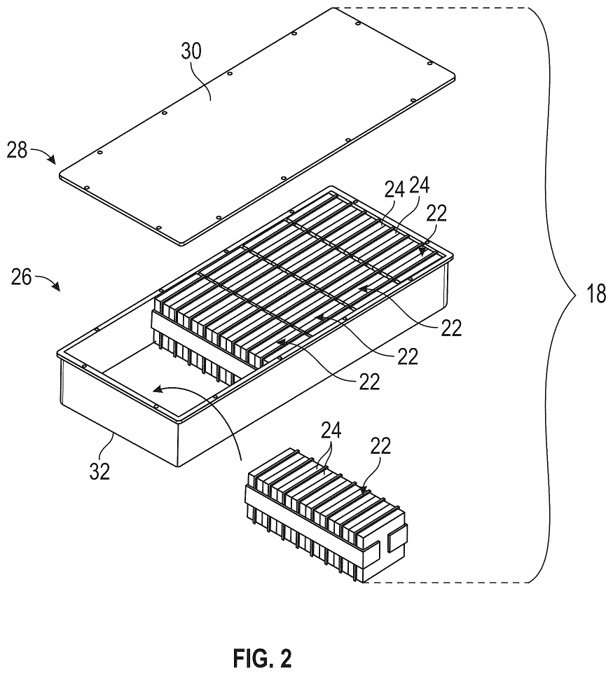

FIG. 2 schematically illustrates additional details associated with the traction battery pack 18 of the electrified vehicle 10. The traction battery pack 18 may include one or more battery arrays 22 (e.g., battery modules or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 24 may be stacked together along a stack axis to construct a grouping of battery cells 24. The battery arrays 22 may extend in cross-car direction when the traction battery pack 18 is mounted on the electrified vehicle 10. However, other configurations may also be possible. The total numbers of battery arrays 22 and battery cells 24 provided within the traction battery pack 18 are not intended to limit this disclosure.

In an embodiment, the battery cells 24 of each battery array 22 are pouch style, lithium-ion cells. However, battery cells having other chemistries (nickel-metal hydride, lead-acid, etc.) could alternatively be utilized within the scope of this disclosure.

The battery arrays 22 and various other battery internal components (e.g., bussed electrical center, battery electric control module, wiring, connectors, etc.) may be housed within an enclosure assembly 28. The enclosure assembly 28 may include an enclosure cover 30 and an enclosure tray 32. The enclosure cover 30 may be secured (e.g., bolted, welded, adhered, etc.) to the enclosure tray 32 to provide an interior area 26 that houses the battery arrays 22. The size, shape, and overall configuration of the enclosure assembly 28 is not intended to limit this disclosure.

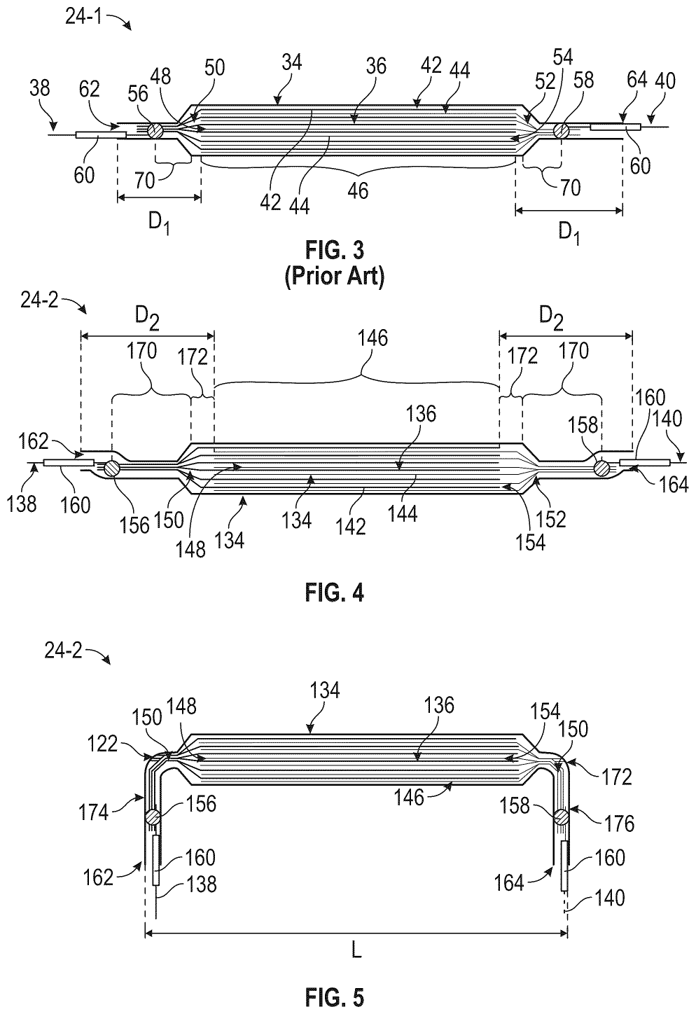

FIG. 3 is a cross-sectional view illustrating a conventional pouch battery cell 24-1 that is commonly utilized within the battery arrays of traction battery packs. The pouch battery cell 24-1 includes an outer pouch 34, an electrode assembly 36 packaged inside the outer pouch 34, a positive tab terminal 38 that protrudes outwardly at a first trim edge 62 of the outer pouch 34, and a negative tab terminal 40 that protrudes outwardly at a second trim edge 64 of the outer pouch 34. Although the positive tab terminal 38 and the negative tab terminal 40 are shown at opposite trim edges, these terminals could extend from a common trim edge within the scope of this disclosure. The outer pouch 34 is typically a multi-layered structure that includes an aluminum film layer between at least two polymer layers.

The electrode assembly 36 may sometimes be referred to as a “jelly-roll,” or a stack of “bi-cells” depending on the design, and includes a cathode 42, an anode 44, and one or more separators (not shown for simplicity and clarity). The cathode 42, anode 44 and separator are wound or stacked together to form a layered body 46 of the electrode assembly 36.

The cathode 42 includes electrode tabs 50 that extend from a first side 48 of the layered body 46, and the anode 44 includes electrode tabs 52 that extend from a second side 54 of the layered body 46. The electrode tabs 50 are secured to the positive tab terminal 38 by a first union (e.g., weld) 56, and the electrode tabs 52 are secured to the negative tab terminal 40 by a second union (e.g., weld) 58.

The positive tab terminal 38 and the negative tab terminal 40 each include a transitional sealing material 60. The transitional sealing material 60 functions to seal an interface between the tab terminals 38, 40 and the outer pouch 34. Although not shown, many other sensitive components are commonly packaged near the first union 56 and the second union 58, such as current collectors, fuses, and/or other sensitive components.

The outer pouch 34 further includes a pair of transition areas 70 where it tapers in width/thickness toward the first and second trim edges 62, 64. The electrode tabs 50 align closer to one another near the centerline axis of the pouch battery cell 24-1 within one of the transition areas 70, and the electrode tabs 52 align closer to one another near the cell centerline axis within the other transition area 70.

In the conventional pouch battery cell 24-1, a distance DI extends between the first side 48 of the layered body 46 and the first trim edge 62 and between the second side 54 of the layered body 46 and the second trim edge 64. The distance DI is relatively small. For example, the distance DI is typically between about 17 mm and about 18 mm. The unions 56, 58 and other sensitive components of the pouch battery cell 24-1 are therefore located relatively close to the layered body 46. This design typically prevents folding the pouch battery cell 24-1 in the spaces between the layered body 46 and the trim edges 62, 64 because folding in these areas can impair the functionality of the sensitive components of the pouch battery cell 24-1. The pouch battery cell 24-1 therefore effectively increases the required volume of the cell without providing any added energy density.

FIGS. 4-5 illustrate a pouch battery cell 24-2 that provides advantages over the conventional pouch battery cell 24-1 of FIG. 3. The pouch battery cell 24-2 could be utilized within the battery arrays 22 of the traction battery pack 18 of FIGS. 1-2, for example.

The pouch battery cell 24-2 includes an outer pouch 134, an electrode assembly 136 packaged inside the outer pouch 134, a positive tab terminal 138 that protrudes outboard of a first trim edge 162 of the outer pouch 34, and a negative tab terminal 140 that protrudes outboard of a second trim edge 164 of the outer pouch 134. The outer pouch 134 may be a multi-layered structure that includes an aluminum film layer and a polymer portion.

The electrode assembly 136, which may be referred to as a “jelly-roll” or active material, includes a cathode 142, an anode 144, and one or more separators (not shown for simplicity and clarity). The cathode 142, anode 144 and separator may be wound or stacked together to form a layered body 146 of the electrode assembly 136.

The cathode 142 includes electrode tabs 150 that extend from a first side 148 of the layered body 146, and the anode 144 includes electrode tabs 152 that extend from a second side 154 of the layered body 146. The electrode tabs 150 may be secured to the positive tab terminal 138 by a first union (e.g., weld) 156, and the electrode tabs 152 may be secured to the negative tab terminal 140 by a second union (e.g., weld) 158.

The positive tab terminal 138 and the negative tab terminal 140 may each include a transitional sealing material 160. The transitional sealing material 160 is configured to seal an interface between the tab terminals 138, 140 and the outer pouch 134. Although not shown, may other sensitive components may be packaged near the first union 156 and the second union 158, such as current collectors, fuses, and/or other sensitive components.

The outer pouch 134 may include a pair of transition areas 170 where the outer pouch 134 tapers in width/thickness toward the first and second trim edges 162, 164. The electrode tabs 150 may align closer to one another near the cell centerline axis within one of the transition areas 170, and the electrode tabs 152 may align closer to one another near the cell centerline axis within the other transition area 170. The first union 156 and the second union 158 may be located slightly outboard of the respective transition areas 170.

The outer pouch 134 may additionally include a pair of electrode extension areas 172. One of the electrode extension areas 172 may extend between the first side 148 of the layered body 146 and a first of the transition areas 170, and the other of the electrode extension areas 172 may extend between the second side 154 of the layered body 146 and the other of the transitions areas 170. Notably, the conventional pouch battery cell 24-1 does not include electrode extension areas.

A distance D2 extends between the first side 148 of the layered body 146 and the first trim edge 162 and between the second side 154 of the layered body 146 and the second trim edge 164. Due to the electrode extension areas 172, the distance D2 is greater than the distance D1 of the conventional pouch battery cell 24-1. In an embodiment, the distance D2 is between about 23 mm and about 30 mm. However, the distance D2 could encompass other ranges within the scope of this disclosure. In this disclosure, the term “about” means that the expressed quantities or ranges need not be exact but may be approximated and/or larger or smaller, reflecting acceptable tolerances, conversion factors, measurement error, etc.

The electrode tabs 150, 152 of the pouch battery cell 24-2 may be lengthened in the electrode extension areas 172 compared to the electrode tabs of the conventional pouch battery cell 24-1. By virtue of this lengthening, the unions 156, 158 and other sensitive components of the pouch battery cell 24-2 may be located further from the layered body 146 compared to the conventional pouch battery cell 24-1.

The electrode extension areas 172 and the lengthened electrode tabs 150, 152 facilitate folding of the pouch battery cell 24-2 into a more compact configuration such as that shown in FIG. 5. The portions of the electrode tabs 150, 152 located within the electrode extensions areas 172 are foldable/bendable and are therefore able to robustly endure the folding process (unlike, for example, the unions 156, 158 and other nearby sensitive components). As shown, the pouch battery cell 24-2 may be folded/bent immediately adjacent to the first side 148 of the layered body 146 to provide a first foldable portion 174, and the pouch battery cell 24-2 may be folded/bent immediately adjacent to the second side 154 of the layered body 146 to provide a second foldable portion 176. An overall length L of the pouch battery cell 24-2 is reduced in the compact configuration, thereby increasing packaging efficiency and battery energy density compared to the conventional pouch battery cell 24-1.

In an embodiment, the first foldable portion 174 and the second foldable portion 176 are bent between about 90 degrees and about 180 degrees relative to the center portion of the outer pouch 134 that contains the layered body 146. However, other configurations are contemplated within the scope of this disclosure.

The foldable pouch battery cell design variation described herein enables a more compact packaging of pouch style battery cells. The proposed designs move sensitive component of the cell further away from the layered body of the jelly-roll active material and add a flexible portion of the cell that is capable of being bent by 90 degrees or more. The compact design facilities increased energy density compared to conventional pouch battery cell designs.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A pouch battery cell, comprising:
an outer pouch;
an electrode assembly inside the outer pouch and including a layered body and a first plurality of electrode tabs that extend outward at a first side of the layered body;
a first tab terminal joined to the first plurality of electrode tabs and extending to a location that is outboard of a first trim edge of the outer pouch; and
a first foldable portion provided immediately adjacent to the first side of the layered body.

2. The pouch battery cell as recited in claim 1, wherein the first foldable portion is established by an electrode extension area of the outer pouch and lengthened portions of the first plurality of electrode tabs.

3. The pouch battery cell as recited in claim 2, wherein each of the lengthened portions of the first plurality of electrode tabs extends between a first side of a transition area and a union arear of the outer pouch that is arranged outboard of the electrode extension area.

4. The pouch battery cell as recited in claim 1, wherein the first foldable portion is bent between about 90 degrees and about 180 degrees relative to a portion of the outer pouch that contains the layered body.

5. The pouch battery cell as recited in claim 1, wherein a distance between the first side of the layered body and the first trim edge is between about 23 mm and about 30 mm.

6. The pouch battery cell as recited in claim 1, wherein the electrode assembly includes a second plurality of electrode tabs that extend outward at a second side of the layered body, and further comprising a second tab terminal joined to the second plurality of electrode tabs and extending to a location that is outboard of a second trim edge of the outer pouch, and a second foldable portion provided immediately adjacent to the second side of the layered body.

7. The pouch battery cell as recited in claim 6, wherein the second foldable portion is established by an electrode extension area of the outer pouch and lengthened portions of the second plurality of electrode tabs.

8. The pouch battery cell as recited in claim 6, wherein the first plurality of electrode tabs are cathode electrode tabs, and the second plurality of electrode tabs are anode electrode tabs.

9. The pouch battery cell as recited in claim 6, wherein the second foldable portion is bent between about 90 degrees and about 180 degrees relative to a portion of the outer pouch that contains the layered body.

10. The pouch battery cell as recited in claim 6, wherein a distance between the second side of the layered body and the second trim edge is between about 23 mm and about 30 mm.

11. A pouch battery cell, comprising:
an outer pouch;
an electrode assembly inside the outer pouch and including a layered body and a first plurality of electrode tabs that extend outward at a first side of the layered body; and
a first tab terminal joined to the first plurality of electrode tabs and extending to a location that is outboard of a first trim edge of the outer pouch,
wherein a first distance between the first side of the layered body and the first trim edge is between about 23 mm and about 30 mm.

12. The pouch battery cell as recited in claim 11, wherein the electrode assembly includes a second plurality of electrode tabs that extend outward at a second side of the layered body, and further comprising a second tab terminal joined to the second plurality of electrode tabs and extending to a location that is outboard of a second trim edge of the outer pouch.

13. The pouch battery cell as recited in claim 12, wherein the first distance extends between the second side of the layered body and the second trim edge.

14. The pouch battery cell as recited in claim 11, comprising a first foldable portion provided immediately adjacent to the first side of the layered body.

15. The pouch battery cell as recited in claim 14, wherein the first foldable portion is established by an electrode extension area of the outer pouch and lengthened portions of the first plurality of electrode tabs.

16. The pouch battery cell as recited in claim 15, wherein each of the lengthened portions of the first plurality of electrode tabs extends between the first side of the layered body and a transition area of the outer pouch that is arranged outboard of the electrode extension area.

17. The pouch battery cell as recited in claim 14, wherein the first foldable portion is bent between about 90 degrees and about 180 degrees relative to a portion of the outer pouch that contains the layered body.

18. The pouch battery cell as recited in claim 17, comprising a second foldable portion provided immediately adjacent to a second side of the layered body.

19. The pouch battery cell as recited in claim 18, wherein the second foldable portion is bent between about 90 degrees and about 180 degrees relative to a portion of the outer pouch that contains the layered body.

20. The pouch battery cell as recited in claim 18, wherein the second foldable portion is established by an electrode extension area of the outer pouch and lengthened portions of a second plurality of electrode tabs of the electrode assembly.
